(19) United States
(12) Patent Application Publication
(10) Pub. No.: US 2026/0005378 A1
(43) Pub. Date: Jan. 1, 2026

(54) CORRUGATED SHIELD FOR TRACTION BATTERY PACK

(71) Applicant: Ford Global Technologies, LLC, Dearborn, MI (US)

(72) Inventors: Mihir Devendra Upadhye, Ann Arbor, MI (US); Daniel Paul Roberts, Livonia, MI (US); Jie Deng, Novi, MI (US); Nathan Lee, Novi, MI (US)

(21) Appl. No.: 18/760,696

(22) Filed: Jul. 1, 2024

(51) Int. Cl. H01M 50/291; B60L 50/64; H01M 10/613; H01M 10/625; H01M 10/647; H01M 10/6568; H01M 50/211; H01M 50/227; H01M 50/249; H01M 50/271; H01M 50/293; H01M 50/342

(52) U.S. Cl. CPC H01M 50/291; H01M 10/613; H01M 10/625; H01M 10/647; H01M 10/6568; H01M 50/211; H01M 50/227; H01M 50/249; H01M 50/271; H01M 50/293; H01M 50/3425; B60L 50/64; H01M 2200/20; H01M 2220/20

(57) ABSTRACT

A traction battery pack assembly, includes an enclosure assembly, a cell stack within an interior of the enclosure assembly, and a corrugated shield. The cell stack has one or more battery cells. The corrugated shield is disposed between the cell stack and an area of the enclosure assembly. The corrugated shield can shield the enclosure assembly from vent byproducts.

### TECHNICAL FIELD

This disclosure details exemplary assemblies and methods that shield areas of a traction battery pack and, more particularly, to shielding those area from vent byproducts released from one or more battery cells.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery pack assembly can power the electric machines. As part of an immersion thermal management system, liquid coolant can be moved through the traction battery pack to help manage thermal energy within the traction battery pack.

### SUMMARY

In some aspects, the techniques described herein relate to a traction battery pack assembly, including: an enclosure assembly; a cell stack within an interior of the enclosure assembly, the cell stack having one or more battery cells; and a corrugated shield disposed between the cell stack and an area of the enclosure assembly.

In some aspects, the techniques described herein relate to a traction battery pack assembly, wherein the corrugated shield is a metal or a metal alloy.

In some aspects, the techniques described herein relate to a traction battery pack assembly, wherein the corrugated shield supports the cell stack.

In some aspects, the techniques described herein relate to a traction battery pack assembly, wherein supporting the cell stack at a position spaced from the enclosure assembly establishes at least one immersion coolant channel between the one or more battery cells and the enclosure assembly.

In some aspects, the techniques described herein relate to a traction battery pack assembly, further including a liquid coolant within the at least one immersion coolant channel.

In some aspects, the techniques described herein relate to a traction battery pack assembly, wherein the one or more battery cells are one or more pouch-style battery cells.

In some aspects, the techniques described herein relate to a traction battery pack assembly, wherein the corrugated shield is a first corrugated shield that is above the cell stack, and further including a second corrugated shield that is beneath the cell stack.

In some aspects, the techniques described herein relate to a traction battery pack assembly, wherein the corrugated shield directly contacts the one or more battery cells of the cell stack.

In some aspects, the techniques described herein relate to a traction battery pack assembly, wherein the corrugated shield includes a plurality of corrugations, the plurality of corrugations interfacing directly with the one or more battery cells.

In some aspects, the techniques described herein relate to a traction battery pack assembly, wherein each corrugation in plurality of corrugations directly contacts more than one of the battery cells.

In some aspects, the techniques described herein relate to a traction battery pack assembly, further including a thermal interface material between the plurality of corrugations and the one or more battery cells.

In some aspects, the techniques described herein relate to a traction battery pack assembly, wherein each battery cell in the one or more battery cells includes one or more battery cell vents, the plurality of corrugations offset from the one or more battery cell vent along a cell stack axis of the cell stack.

In some aspects, the techniques described herein relate to a traction battery pack assembly, wherein the enclosure assembly is a polymer-based enclosure assembly.

In some aspects, the techniques described herein relate to a traction battery pack assembly, further including a thermal interface material between the corrugated shield and the enclosure assembly.

In some aspects, the techniques described herein relate to a traction battery pack assembly, wherein the enclosure assembly includes an enclosure cover and an enclosure tray that cooperate to provide an enclosed internal area that houses the cell stack.

In some aspects, the techniques described herein relate to a traction battery pack assembly, wherein the corrugated shield is a first corrugated shield that is disposed between the enclosure cover and the cell stack, and further including a second corrugated shield that is disposed between the enclosure tray and the cell stack.

In some aspects, the techniques described herein relate to a traction battery pack assembly, wherein a first side of the corrugated shield interfaces directly with a first area of the enclosure assembly, and an opposite, second side of the corrugated shield interfaces directly with a second area of the cell stack, the first area greater than the second area.

In some aspects, the techniques described herein relate to a traction battery pack assembly, wherein the corrugated shield is a stamped corrugated sheet.

In some aspects, the techniques described herein relate to a traction battery pack assembly, wherein the corrugated shield includes a plurality of perforations.

In some aspects, the techniques described herein relate to a method of managing thermal energy within a traction battery pack, including: immersing at least a portion of a cell stack within a liquid coolant to manage thermal energy within the cell stack, the cell stack including one or more battery cells disposed along a cell stack axis, the cell stack housed within an enclosure assembly; supporting the cell stack within the enclosure assembly using a corrugated sheet; and communicating the liquid coolant through channels provided by the corrugated sheet.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack.

FIG. 2 illustrates a perspective, schematic view of the battery pack of FIG. 1.

FIG. 3 illustrates a section view at line 3-3 in FIG. 2 showing a cell stack of the battery pack within an enclosure of the battery pack between first and second corrugated shields according to an exemplary aspect of the present disclosure.

FIG. 4 illustrates a close-up view of an area of FIG. 3 during a venting event.

FIG. 5 illustrates a perspective view of a battery cell from battery pack of FIG. 3.

FIG. 6 illustrates a perspective view of a portion of the first corrugated shield from the battery pack of FIG. 3.

### DETAILED DESCRIPTION

An immersion thermal management system can be used to manage thermal energy in a traction battery pack. The immersion thermal management system immerses at least some components, such as battery cells, of the traction battery pack in a liquid coolant. This disclosure is directed toward shielding areas of a battery pack having an immersion thermal management system.

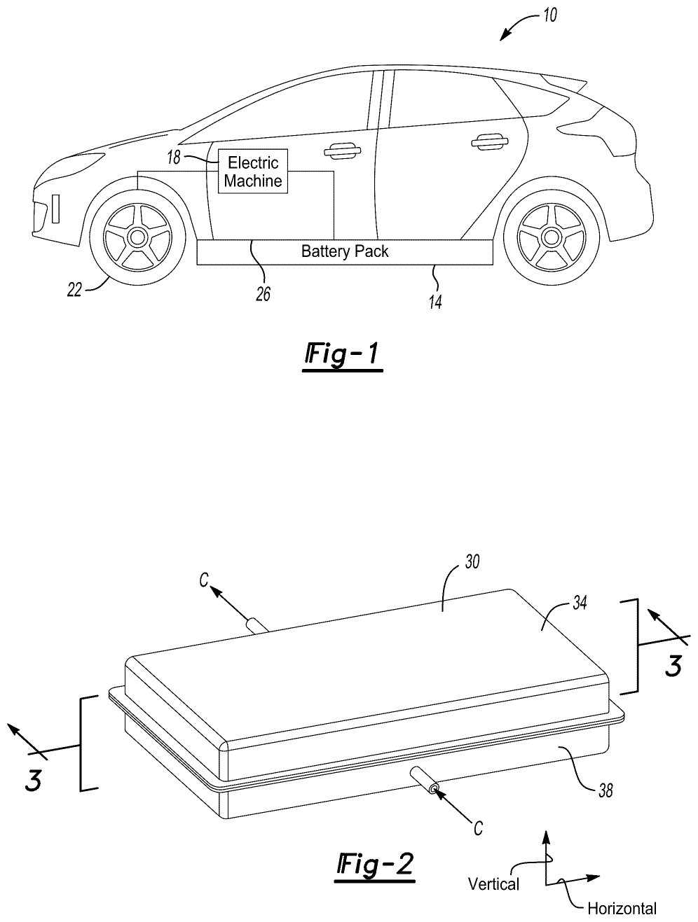

With reference to FIG. 1, an electrified vehicle 10 includes a traction battery pack 14, an electric machine 18, and wheels 22. The traction battery pack 14 powers the electric machine 18, which can convert electrical power to mechanical power to drive the wheels 22.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

The traction battery pack 14 is, in the exemplary embodiment, secured to an underbody 26 of the electrified vehicle 10. The traction battery pack 14 could be located elsewhere on the electrified vehicle 10 in other examples.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

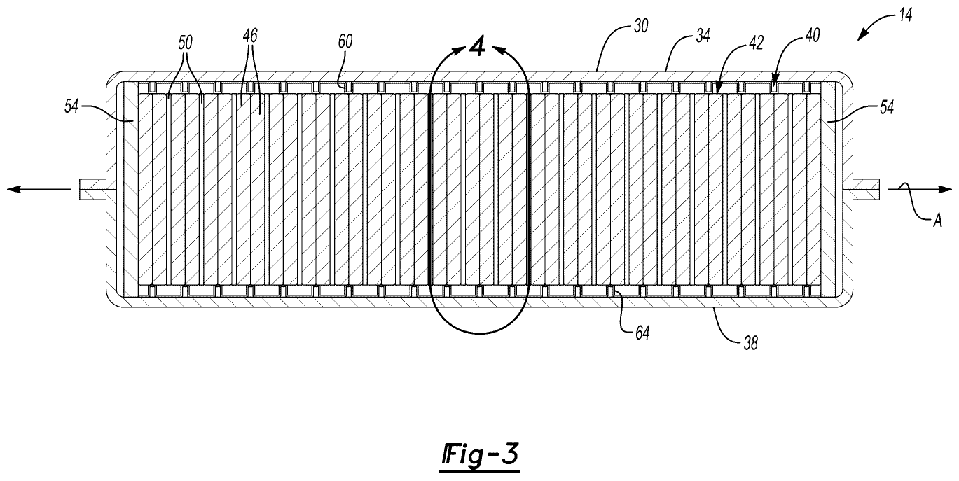

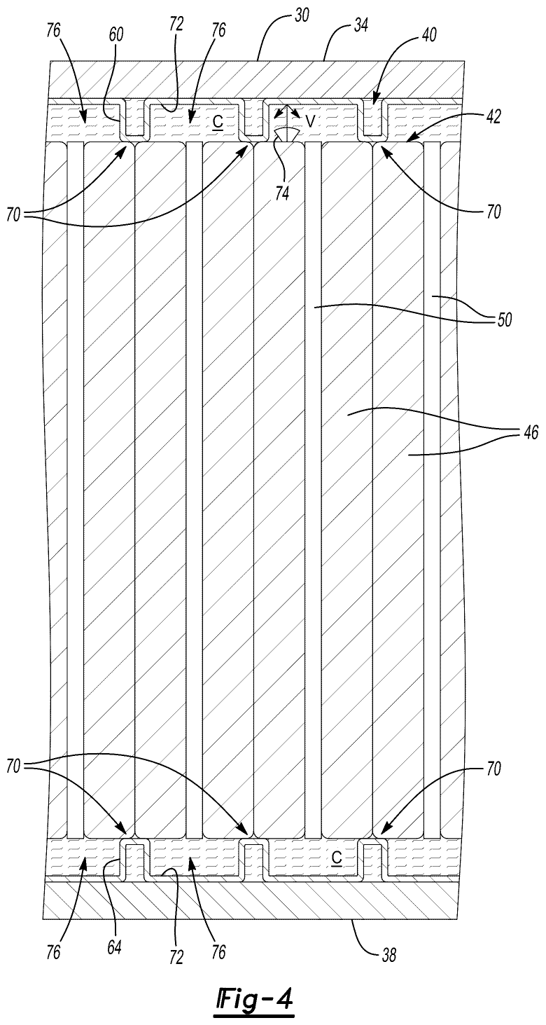

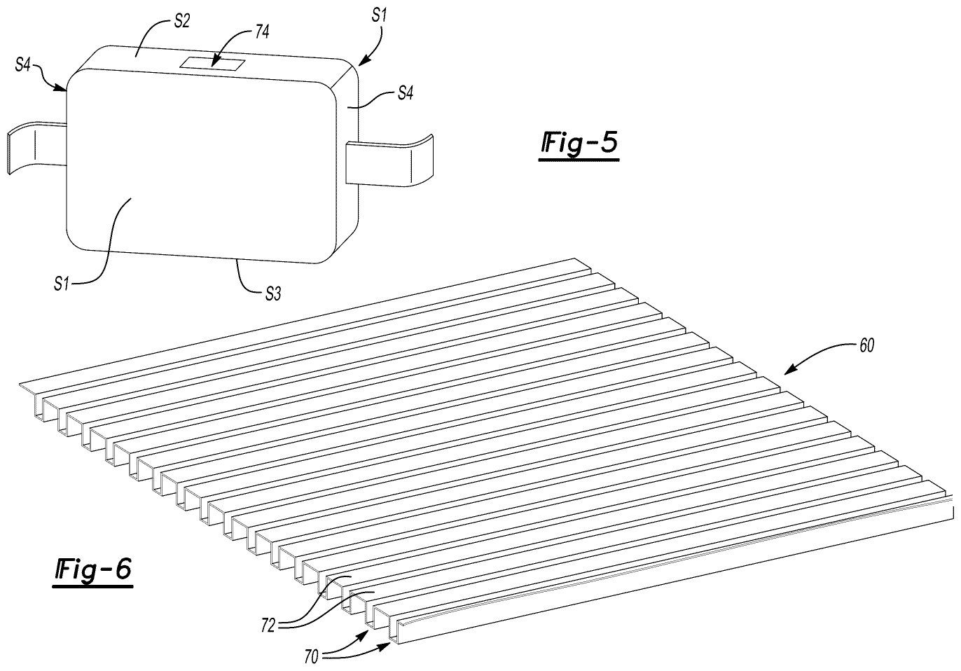

Referring now to FIGS. 2-6, the battery pack 14 includes an enclosure assembly 30 having a cover 34 and a tray 38. The cover 34, in this example, is vertically above the tray 38. In other examples, however, the cover 34 could be arranged below, or to a side of the tray 38.

Vertical is with reference to ground and a general orientation of the vehicle 10 and the battery pack 14 during operation. Various terms such as “above,” “below,” “top,” and “bottom” are used relative to the arrangement of the components of the battery pack 14 in the various drawings and should not otherwise be deemed limiting. These terms are with reference to the general orientation of the battery pack 14 when installed within the vehicle 10 of FIG. 1.

The cover 34 and the tray 38 are polymer-based in this example. In other examples, one or both of the cover 34 and the tray 38 can be a metal, metal alloy, or some other material. The cover 34 is secured to the tray 38 using adhesive and mechanical fasteners in one example of this disclosure. The cover 34 and tray 38 could be connected using other fluid-tight connection techniques in other examples. Further, while an exemplary enclosure assembly 30 is shown in the drawings, the enclosure assembly 30 may vary in size, shape, and configuration within the scope of this disclosure. The cover 34, for example, could include multiple separate pieces that, when combined, provide the cover 34.

In this disclosure, the traction battery pack 14 includes at least one cell stack 42 having one or more individual battery cells 46 disposed along a cell stack axis A. The cover 34 and the tray 38 cooperate to provide an enclosed internal area 40 that houses the cell stack 42.

The cell stack 42 could include any number of battery cells 46. The battery pack 14 could also employ any number of cell stacks 42 within the enclosure assembly 30. Thus, this disclosure is not limited to the exact configuration shown. Further, while the battery cells 46 of the exemplary embodiment are positioned side-by-side relative to one another along the cell stack axis A, other configurations are also contemplated within the scope of this disclosure, including but not limited to embodiments in which the battery cells 46 are stacked on top of one another, for example.

The cell stack 42 is arranged in the interior area 40 of the enclosure assembly 30 between the tray 38 and the cover 34. During operation, a thermal management system can route non-conductive (i.e., dielectric) coolant C through the interior area 40 over areas of the cell stack 42 to manage thermal energy within the cell stack 42. The coolant C can, for example, take on heat from the cell stack 42 to cool the cell stack 42.

The thermal management system is an immersion thermal management system at least because portions of the battery pack 14, here at least the battery cells 46 of the cell stack 42 are immersed in the coolant C.

The coolant C is a dielectric fluid in this example. The coolant can be an oil. The coolant can be non-conductive and can be a liquid that is designed for immersion cooling of the battery cells 46 and other components. The chemical makeup and design characteristics (e.g., dielectric constant, maximum breakdown strength, boiling point, etc.) of the coolant C can vary depending on the environment that the battery pack 14 is designed to be utilized in. Unlike some conductive glycol coolants utilized within cold plate cooling systems, the coolant C of the exemplary embodiment is designed for immersion cooling and allows for direct contact with the battery cells 46 and other electrified components.

In an example, the coolant C takes on thermal energy from components within the interior of the enclosure assembly 30 and is then routed to, for example, a heat exchanger outside the battery pack 14. At the heat exchanger, thermal energy is release from the coolant C. The coolant C is then recirculated back through the interior area 40.

The cell stack 42 further includes a plurality of dividers 50 and a pair of endplates 54. The dividers 50 can be foam. The dividers 50 are disposed axially between groups of the battery cells 46 along the cell stack axis A. The dividers 50 and the battery cells 46 are sandwiched between the endplates 54 along the cell stack axis A.

Within the interior area 40, the battery pack 14 further includes a first corrugated shield 60 and a second corrugated shield 64 that can help to support and position the cell stack 42. In the exemplary embodiment, the first corrugated shield 60 is vertically above the cell stack 42 between the cell stack 42 and the cover 34. The second corrugated shield 64 is vertically beneath the cell stack 42 between the cell stack 42 and the tray 38. The battery pack 14, in another example, could include one corrugated shield or more than two corrugated shields.

The first corrugated shield 60 and the second corrugated shield 64 are, in this example, a metal or metal alloy material. The first corrugated shield 60 and the second corrugated shield 64 each include a plurality of corrugations 70 connected by spanning portions 72.

The first corrugated shield 60 and the second corrugated shield 64 can be stamped corrugated shields. A person having skill in this art would understand how to structurally distinguish a stamped component from a component that is not stamped. Thus, describing corrugated shields as stamped corrugated shields implicates structure to the corrugated shields.

In an embodiment, the battery cells 46 are pouch-style, lithium-ion cells. However, battery cells having other geometries (cylindrical, prismatic, etc.), other chemistries (nickel-metal hydride, lead-acid, etc.), or both could alternatively be utilized within the scope of this disclosure.

The battery cells 46 each have opposing axially facing sides S1, a top side S2, a bottom side S3, and opposing laterally facing sides S4. The axially facing sides S1 can be considered broad sides of the battery cells 46 as these sides are broader than the top sides S2, the bottom sides S3, or the laterally facing sides S4. In an installed position, the top sides S2 of the battery cells 46 face vertically upward from the cell stack axis A, and the bottom sides S3 of the battery cells 46 face downward away from the cell stack axis A.

From time to time, pressure and thermal energy levels within one or more of the battery cells 46 can increase. The pressure and thermal energy increase can be due to an overcharge condition, for example. The pressure and thermal energy increase can cause a vent 74 within that battery cell 46 to rupture.

With the vent 74 ruptured, vent byproducts V, such as gas and debris, are expelled from within the interior of the battery cell 46 relieving the pressure differential. The vent byproducts V are released from within the battery cell 46 through the vent 74, which is within an outer case of the battery cell 46. The vent 74 can be a membrane that yields response to increased internal pressure within the battery cell 46. The vent 74 could instead or additionally include simply a ruptured area of an outer case of the battery cell 36.

The vent byproducts V can have a relatively high thermal energy level. The first corrugated shield 60 is disposed between the vents 74 of the battery cells 46 and the cover 34. The corrugated shield 60 blocks the vent byproducts V from moving through the coolant C directly against the cover 34. This can help to shield the cover 34, which, as described above can be polymer-based.

The example vents 74 open through the top sides S1 of the battery cells 46. Other battery cells could include vents in other sides. A corrugated shield could be positions along those other sides to shield other areas of the enclosure assembly 30.

The first corrugated shield 60 and the second corrugated shield 64 support the cell stack 42, at a position spaced from the enclosure assembly 30 (i.e., spaced from the enclosure cover 34 and the enclosure tray 38). The first corrugated shield 60 establishes channels 76 for communicating the coolant C over the top sides S2 of battery cells 46 of the cell stack 42. The second corrugated shield 64 establishes channels 76 for communicated the coolant C over the bottom sides S3 of the battery cells 46. The first corrugated shield 60 and the second corrugated shield 64 can be perforated with a plurality of perforations, which can help to turbulate the coolant C and enhance thermal energy transfer.

In this example, the corrugations 70 interface directly with the battery cells 46 of the cell stack 42. The corrugations 70 can directly contact the battery cells 46, can be bonded to the battery cells 46 using an adhesive thermal interface material, or some combination of these. The corrugations 70 each interface directly with two battery cells 46 in this example. That is, each corrugation 70 of the first corrugated shield 60 interfaces directly with the top sides S2 of two battery cells 46 of the cell stack 42, and each corrugation 70 of the second corrugated shield 64 interfaces directly with the bottom sides S3 of two battery cells 46 of the cell stack 42.

Notably, the corrugations 70 are offset from the vents 74 along the cell stack axis A. That is, the corrugations 70 of the first corrugated shield 60 contact the top sides S2 without overlapping the vents 74.

The spanning portions 72 of the first corrugated shield 60 have a width W1 that is greater than a width W2 of the corrugations 70. Thus, on a first side of the corrugated shield 60, an area of the first corrugated shield 60 that interfaces with the enclosure assembly 30 is greater than an area of the first corrugated shield 60 that interfaces with the battery cells 46 on an opposite, second side of the corrugated shield 60. Making the corrugations 70 narrower than the spanning portions 72 can help to keep the corrugations 70 from covering the vents 74.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack assembly, comprising:
an enclosure assembly;
a cell stack within an interior of the enclosure assembly, the cell stack having one or more battery cells; and
a corrugated shield disposed between the cell stack and an area of the enclosure assembly.

2. The traction battery pack assembly of claim 1, wherein the corrugated shield is a metal or a metal alloy.

3. The traction battery pack assembly of claim 1, wherein the corrugated shield supports the cell stack.

4. The traction battery pack assembly of claim 3, wherein supporting the cell stack at a position spaced from the enclosure assembly establishes at least one immersion coolant channel between the one or more battery cells and the enclosure assembly.

5. The traction battery pack assembly of claim 4, further comprising a liquid coolant within the at least one immersion coolant channel.

6. The traction battery pack assembly of claim 1, wherein the one or more battery cells are one or more pouch-style battery cells.

7. The traction battery pack assembly of claim 1, wherein the corrugated shield is a first corrugated shield that is above the cell stack, and further comprising a second corrugated shield that is beneath the cell stack.

8. The traction battery pack assembly of claim 1, wherein the corrugated shield directly contacts the one or more battery cells of the cell stack.

9. The traction battery pack assembly of claim 1, wherein the corrugated shield includes a plurality of corrugations, the plurality of corrugations interfacing directly with the one or more battery cells.

10. The traction battery pack assembly of claim 9, wherein each corrugation in plurality of corrugations directly contacts more than one of the battery cells.

11. The traction battery pack assembly of claim 9, further comprising a thermal interface material between the plurality of corrugations and the one or more battery cells.

12. The traction battery pack assembly of claim 9, wherein each battery cell in the one or more battery cells includes one or more battery cell vents, the plurality of corrugations offset from the one or more battery cell vent along a cell stack axis of the cell stack.

13. The traction battery pack assembly of claim 1, wherein the enclosure assembly is a polymer-based enclosure assembly.

14. The traction battery pack assembly of claim 1, further comprising a thermal interface material between the corrugated shield and the enclosure assembly.

15. The traction battery pack assembly of claim 1, wherein the enclosure assembly includes an enclosure cover and an enclosure tray that cooperate to provide an enclosed internal area that houses the cell stack.

16. The traction battery pack assembly of claim 15, wherein the corrugated shield is a first corrugated shield that is disposed between the enclosure cover and the cell stack, and further comprising a second corrugated shield that is disposed between the enclosure tray and the cell stack.

17. The traction battery pack assembly of claim 1, wherein a first side of the corrugated shield interfaces directly with a first area of the enclosure assembly, and an opposite, second side of the corrugated shield interfaces directly with a second area of the cell stack, the first area greater than the second area.

18. The traction battery pack assembly of claim 1, wherein the corrugated shield is a stamped corrugated sheet.

19. The traction battery pack assembly of claim 1, wherein the corrugated shield includes a plurality of perforations.

20. A method of managing thermal energy within a traction battery pack, comprising:
immersing at least a portion of a cell stack within a liquid coolant to manage thermal energy within the cell stack, the cell stack including one or more battery cells disposed along a cell stack axis, the cell stack housed within an enclosure assembly;
supporting the cell stack within the enclosure assembly using a corrugated sheet; and
communicating the liquid coolant through channels provided by the corrugated sheet.
